(19) United States
(12) Patent Application Publication
(10) Pub. No.: US 2010/0307196 A1
(43) Pub. Date: Dec. 9, 2010

(54) BURNER INJECTION SYSTEM FOR GLASS MELTING

(76) Inventor: Andrew P. RICHARDSON, Clinton, NJ (US)

Correspondence Address: The BOC Group, Inc., 575 MOUNTAIN AVENUE, MURRAY HILL, NJ, 07974-2082, US

(21) Appl. No.: 12/480,130

(22) Filed: Jun. 8, 2009

(51) Int. Cl. C03B 5/16; C03B 19/00

(52) U.S. Cl. 65/134.4; 65/356; 65/355

(57) ABSTRACT

A burner for melting glass forming batch material includes a burner assembly constructed and arranged with a first passage for providing a fuel stream and a second passage for providing an oxidant stream, the first and second streams coacting to produce a supersonic combustion jet flame penetrable into glass melt. A method for melting glass forming batch material is also provided and includes providing a fuel stream; providing an oxidant stream; mixing the fuel and oxidant streams with sufficient force for providing a supersonic combustion jet flame; directing the supersonic combustion jet flame to contact the glass forming batch material; and penetrating the glass forming batch material to a select depth with the supersonic combustion jet flame.

### BACKGROUND OF THE INVENTION

The inventive embodiments relate to melting glass batch materials.

The melting of glass by combustion processes, in particular high efficiency melting, may include submerged combustion, wherein the flame is injected via burners mounted below the glass melt level. A similar effect may be created by impinging a high velocity flame downward onto and penetrating into the liquid bath, as practiced in an electric arc furnace (EAF) for the steel industry.

Conventional glass melting from above depends upon the transfer of heat from above the glass surface and by heat transferred by the liquid glass flowing under the unmolten batch material. The rate at which this heat is transferred from above the glass is dependent largely upon radiation from the crown material which imposes an upper limit on the amount of heat transferred and thus the production rate of the furnace. Heat transfer to the upper surface of the glass melt may be augmented by the nature of the combustion process itself, i.e. highly radiative flames and impinging flames can also increase the heat transfer rate at the glass melt. In such systems combustion space and exhaust gas temperatures can be high and result in high NOx emissions and heat losses in the exhaust gas. Glass melting from below the melt is dependent upon the glass temperature below the batch and its movement.

Submerged combustion provides for intimate contact of the combustion gases with the glass melt. Furthermore, submerged combustion creates agitation to the glass bath, which provides better mixing between undissolved batch material and molten glass. Both factors contribute to more rapid melting and lower exhaust gas temperatures.

However, submerged combustion burners and their integration into the side or bottom of the melter below the molten glass level present problems for burner maintenance and repair, operation, monitoring, and localized wear.

### BRIEF DESCRIPTION OF THE DRAWINGS

For a more complete understanding of the present embodiments, reference may be had to the following detailed description of the embodiments taken in conjunction with the drawing figures, of which:

FIG. 1 shows a schematic of a burner injection system embodiment for glass melting;

FIG. 2 shows a schematic of components of the embodiment of FIG. 1; and

FIG. 3 shows a schematic of a still other components of another burner injection system embodiment which can be used in FIG. 1.

### DETAILED DESCRIPTION OF THE INVENTION

By impinging the surface of the glass with a supersonic combusting jet such that the combusting jet displaces a surface of the glass melt and penetrates into the melt, the benefits of submerged combustion (better heat transfer, high efficiency, low NOx, better mixing, rapid melting) are achieved without the need for a burner or injector to be placed below the glass level.

A further embodiment is the inclusion (by injection or otherwise) of glass forming batch material in the supersonic combusting jet or flame in such a manner that the solid material is directly injected into the body of the glass melt rather than floating on the surface. This further enhances the penetration of the supersonic combusting jet into the melt, and the mixing of the batch and glass material.

The process of creating a submerged combustion effect by impingement of a high momentum supersonic combusting jet from above and its penetration into a bath of liquid glass may include the burner and flame jet disposed vertically or angled with respect to a surface of the glass bath, or injecting glass forming batch material concurrently with the supersonic combusting jet into the glass bath.

Penetration of the high momentum supersonic combusting jet into the glass bath produces a shearing action sufficient to enhance the solution rate of the glass forming batch material. Melting of the glass forming batch material proceeds more quickly, and/or at a lower temperature than occurs in a comparable conventional glass melting furnace.

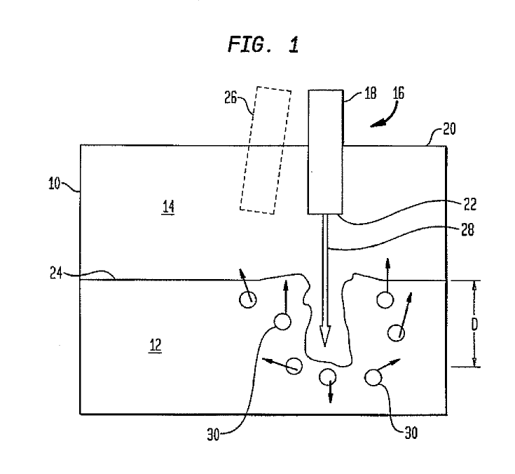

Referring to FIG. 1, a portion of a furnace for a glass melter is shown generally at 10, the furnace 10 having a glass bath 12 or glass melt bath therein above which a combustion atmosphere 14 of the furnace 10 is provided.

An injection system of the inventive embodiment is shown generally at 16 and includes a burner 18 or injector device (for the sake of brevity referred to as a “burner”) mounted to a crown 20 of the furnace 10. The burner 16 is arranged with its exhaust 22 or discharge outlet perpendicular to a surface 24 of the glass bath 12 or alternatively, disposed at an angle other than perpendicular with respect to surface 24 of the glass bath 12, as shown by the broken line 26. The burner 16 is constructed to provide a supersonic flame jet 28 to contact and displace the glass bath 12 such that the jet 28 penetrates into the bath 12 up to a depth indicated as “D” of approximately one-half a depth of the glass bath 12. The supersonic flame jet 28 can penetrate typically from one foot (0.305 meter) to three and one-half feet (0.991 meter) into the glass bath 12. As shown in FIG. 1, such penetration provides the benefits of submerged combustion discussed above. For example, combustion product bubbles 30 enhance heat transfer in the glass bath 12, melting and mixing of the glass bath 12 with incoming glass batch (not shown) introduced into the bath 12.

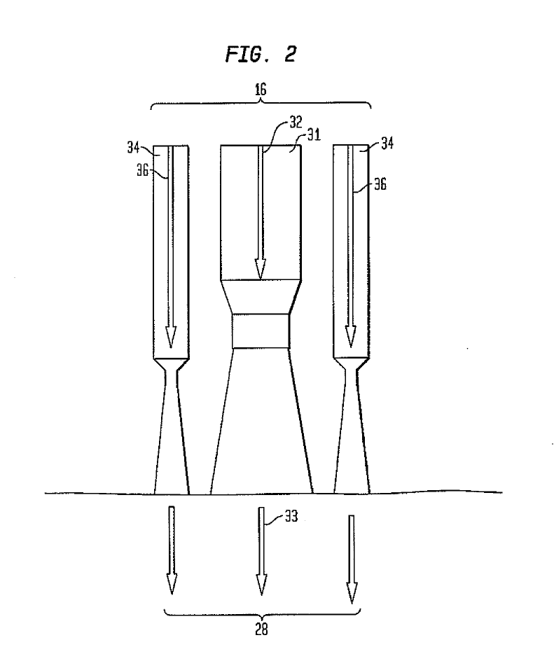

Referring to FIG. 2, the burner 16 includes a high pressure nozzle 31 or a Laval nozzle constructed to be supplied with a high pressure fuel 32 and arranged to provide a high velocity fuel stream 33 from the burner. The high pressure fuel 32 is a gaseous fuel such as methane, natural gas or propane. Flow of the fuel 32 is through the nozzle 31.

A high pressure nozzle 34 or Laval nozzle supplies an oxidant such as an oxygen stream 36 about the fuel nozzle 31 for providing oxygen to mix with the fuel. Regardless of whether the fuel and oxygen streams are mixed internal to the burner 16 or external to the burner 16, the result of the mixing is that the supersonic jet 28 results for contacting and penetrating into the glass bath 12.

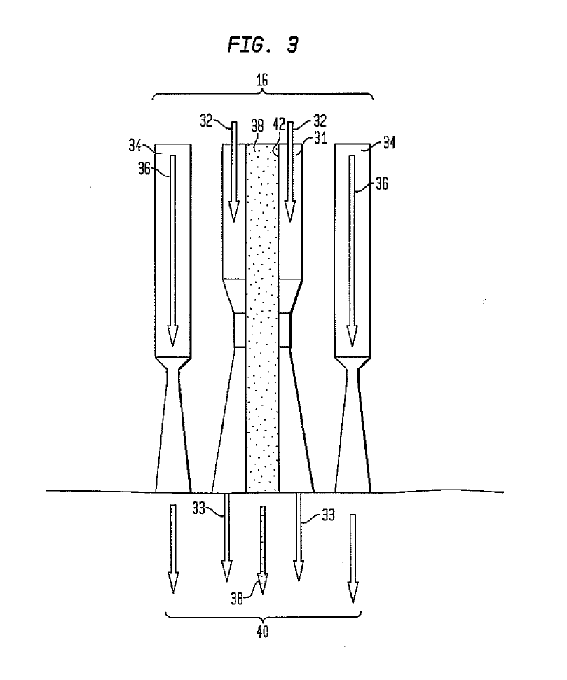

Referring to FIG. 3, another embodiment is shown of the burner 16. In this embodiment, particulate material, such as the glass batch material 38 for the glass bath, is introduced into the high velocity fuel stream 33. The batch material 38 may be in concentrated form. As a supersonic jet 40 leaves the burner 16 directed toward the glass bath 12, the batch feed 38 begins to melt but also provides additional force for the supersonic jet 40 to provide for penetration of the jet into the bath 12. The supersonic jet 28 of FIG. 1 could similarly be replaced by the supersonic jet 40 of FIG. 3.

The supersonic combusting jets 28,40 of FIGS. 1-3 are formed by:
a) Mixing and reaction of separate supersonic oxygen and supersonic fuel streams external to the burner 16,
b) Mixing and reaction of separate supersonic oxygen and subsonic fuel stream external to the burner 16,
c) Mixing and reaction of separate subsonic oxygen and supersonic fuel stream external to the burner 16, or
d) Mixing and reaction of the oxygen stream 36 and the fuel stream 32 within the burner 16 and the emission of the supersonic flame jet 28,40 from the burner 16.

The fuel and oxidant streams 32,36 can be arranged co-axial or as separate streams proximate each other.

The burner 16 can be water-cooled, such as with a water jacket (note shown) for those occasions when the streams are mixed within the burner.

If the solid glass material feed is included in the fuel stream 32, a central passage 42 or channel such as shown in FIG. 3 would be surrounded by the streams 32,36 forming the supersonic flame jet 28,40.

Mixing of the fuel stream 32 and the oxygen stream 36 is done with sufficient force such that said streams 32,36 interact to produce the supersonic jet streams 28,40.

The penetration of a high momentum supersonic flame jet 28,40 into the glass bath 12 produces a shearing action sufficient to enhance the solution rate of the glass forming batch material. Melting of the glass forming batch material in the bath 12 proceeds more quickly, and/or at lower temperatures than occurs in a comparable conventional glass melting furnace. The burner 16 therefore provides for an increased melt rate, reduced melter size necessary for the melt operation, improved efficiency due to lower exhaust gas thermal losses, lower NOx due to lower temperatures, and elimination of submerged burners and complications associated therewith.

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. A burner for melting glass forming batch material, comprising:
a burner assembly constructed and arranged with a first passage for providing a fuel stream and a second passage for providing an oxidant stream, the first and second streams coacting to produce a supersonic combustion jet flame penetrable into a glass melt.

2. The burner according to claim 1, wherein the first and second streams coact internal to the burner assembly.

3. The burner according to claim 1, wherein the first and second streams coact external to the burner assembly.

4. The burner according to claim 1, wherein the second passage surrounds and is coaxial with the first passage.

5. The burner according to claim 1, wherein the fuel and oxidant streams are supersonic.

6. The burner according to claim 1, wherein the fuel stream is subsonic and the oxidant stream is supersonic.

7. The burner according to claim 1, wherein the fuel stream is supersonic and the oxidant stream is subsonic.

8. The burner according to claim 1, wherein the fuel stream comprises gaseous fuel selected from methane, natural gas and propane.

9. The burner according to claim 1, wherein the oxidant comprises oxygen.

10. The burner according to claim 1, wherein the fuel stream comprises particulate material.

11. The burner according to claim 10, wherein the particulate material comprises glass batch material.

12. The burner according to claim 1, wherein the burner assembly is disposed at an angle perpendicular to a surface of the glass melt.

13. The burner according to claim 1, wherein the burner assembly is disposed at an angle other than perpendicular to a surface of the glass melt.

14. A method of melting glass forming batch material, comprising:
providing a fuel stream; providing an oxidant stream; mixing the fuel and oxidant streams with sufficient force for providing a supersonic combustion jet flame; directing the supersonic combustion jet flame to contact the glass forming batch material; and penetrating the glass forming batch material to a select depth with the supersonic combustion jet flame.

15. The method according to claim 14, further comprising introducing particulate material into the fuel stream.

16. A melter for melting glass forming batch material, comprising:
a furnace for containing a bath of glass and glass forming batch material; and
at least one burner mounted in the furnace and directed toward the bath, the burner comprising a fuel nozzle and an oxidant nozzle which coact to produce a supersonic combustion jet flame penetrable into the bath of glass forming batch material.

17. The melter according to claim 16, further comprising particulate material introduced into the fuel nozzle.

18. The melter according to claim 17, wherein the particulate material comprises glass batch material.
